(19) United States
(12) Patent Application Publication
(10) Pub. No.: US 2024/0217307 A1
(43) Pub. Date: Jul. 4, 2024

(54) Vehicle Heating, Ventilation and Air Conditioning System

(71) Applicant: AGCO International GmbH, Neuhausen (CH)

(72) Inventors: Dirk Stallmeier, Marktoberdorf (DE); Andreas Stieglitz, Marktoberdorf (DE); Franz Schwab, Marktoberdorf (DE)

(21) Appl. No.: 18/558,123

(22) PCT Filed: Apr. 27, 2022
(86) PCT No.: PCT/IB2022/053915

§ 371 Date: Oct. 30, 2023

(30) Foreign Application Priority Data
Jun. 8, 2021 (GB) 2108162.5

(51) Int. Cl. B60H 1/00; B60H 3/06

(52) U.S. Cl. CPC B60H 1/00828; B60H 1/00564; B60H 3/0608

(57) ABSTRACT

External air is drawn through a HVAC unit from an exterior air intake and recirculated air through a recirculation air inlet. An air intake management system includes first and second variable speed blowers and an air flow regulator. The air flow regulator defines a number of flow paths through which either exterior or recirculated air is drawn by either the first blower or the second blower. A valve arrangement regulates the flow of air through at least one of the flow paths. Control of the valves and the operating speeds of the blowers enables the amount and relative proportions of the external and recirculated air passing through the HVAC unit to be controlled. One air flow path for external air is permanently open and has an air mass flow sensor to monitor the flow of air.

### CROSS REFERENCE TO RELATED APPLICATIONS

This application is a national phase entry under 35 U.S.C. § 371 of International Patent Application PCT/IB2022/053915, filed Apr. 27, 2022, designating the United States of America and published in English as International Patent Publication WO 2022/259053 A1 on Dec. 15, 2022, which claims the benefit of the filing date of U. K. Patent Application 2108162.5 “Vehicle Heating, Ventilation and Air Conditioning System,” filed Jun. 8, 2021, the entire disclosure of which is incorporated herein by reference.

### FIELD

The present disclosure relates to a vehicle heating, ventilation and air conditioning (HVAC) system, in particular to an HVAC system for an operator environment or cab of an agricultural or a similar off-road vehicle or machine.

### BACKGROUND

It is known to provide agricultural vehicles with an HVAC system in which air to be distributed to the inside of the cab is drawn into the system from the exterior of the vehicle by a blower of a so-called HVAC unit via an external air intake and air filter.

The term “HVAC unit” as used throughout this patent application is to be interpreted as covering a unit which is capable of heating and/or cooling the air which is passed through it. Known HVAC systems for a vehicle cab will typically comprise a heater unit for selectively heating the air and an evaporator for selectively cooling the air to allow for adequate temperature control of the air inside the cab.

Legislation in various countries now requires the use of filters of a particular rating to filter out contaminants from the air which would otherwise be introduced into the operator environment or cab from the exterior of the agricultural vehicle. For example, in the European Union, EU Standard EN 15695 provides for four categories of filter for cabin protection, where Category 2 (hereinafter “CAT2”) protects only against dust but does not protect against aerosols and vapors, Category 3 (CAT3) protects against dust and aerosol, but not vapors, and Category 4 (CAT4) protects against dust, aerosols and vapors. In this context, CAT3 filters tend to be more expensive than CAT2 filters, with CAT4 being most expensive. Throughout this specification, references to a CAT2 or CAT4 filter should be understood as encompassing equivalent filters of a corresponding standard even if not officially classified as CAT2 or CAT4 according to EU Standard EN 15695.

In addition to passing fresh air drawn in from the exterior of the vehicle through an HVAC unit and into the cab, it is known to recirculate air from the cab back through an HVAC unit. This can be particularly advantageous in enabling the temperature in the cab to be brought to a set-point quickly, thus improving the efficiency of the system. The ratio of fresh and recirculated air may be varied depending on requirements. For example, in order to rapidly heat or cool the air in the cab to bring it to a desired set-point temperature, the amount of recirculated air can be increased whilst the amount of fresh air reduced. Alternatively, for defrosting/defogging the windows of the cab, it is desirable to minimize the recirculating air and maximize the amount of fresh air.

In many countries, legislation places limits on the amount of recirculated air and/or fresh air which is circulated in a vehicle cab by an HVAC system depending on operating conditions. Such legislation may require a minimum flow of fresh air into the cab be maintained to ensure air quality to avoid suffocation and to control the CO ratio. However, legislation and/or filter limitations may also limit the amount of fresh air which can be drawn into the cab from the exterior when the vehicle is operating in an environment requiring the use of a CAT 4 filter.

There is a need then for an HVAC system for a vehicle which is better able to regulate the amount of fresh and recirculated air drawn through an HVAC unit into a vehicle cab.

### BRIEF SUMMARY

Embodiments relate to a vehicle HVAC system, a method of operating a vehicle HVAC system, and to a vehicle having such an HVAC system.

In some embodiments, a vehicle HVAC system has an HVAC unit, first and second independently controllable variable speed blowers, each blower being operative in use to draw exterior air into the HVAC unit from an exterior air intake and/or to draw recirculated air from within the cab into the HVAC unit from a recirculation inlet, and an air flow regulator defining a plurality of discrete flow paths. Each flow path connects a respective one of the first and second blowers with a respective one of the exterior air intake and the recirculation inlet only. The air flow regulator comprises a valve arrangement including at least one valve for selectively regulating the flow of air through at least one of the flow paths.

In the HVAC system, the amount and relative proportions of fresh external air and recirculated air passed through the HVAC and into the cab can be regulated by appropriate control of the valve arrangement and independent control of the operating speeds of the first and second blowers.

In an embodiment, the air flow regulator defines a first flow path through which air is drawn from the exterior air intake by the first blower, a second flow path through which air is drawn from the recirculation air inlet by the first blower, and a third flow path through which air is drawn from the recirculation air inlet by the second blower. The valve arrangement is configured to selectively regulate the flow of air through at least the second and third flow paths.

The air flow regulator may also define a fourth flow path through which air is drawn in through the exterior air intake. In one embodiment, the fourth flow path is associated with the first blower, and in another embodiment it is associated with the second blower. Where there is a fourth flow path, the valve arrangement may be configured to selectively regulate the flow of air through the fourth flow path.

The external air intake may comprise two or more external air inlets.

The valve arrangement may comprise a respective valve in each flow path in which the flow of air is regulated, each valve being operable to selectively open and close its respective flow path. At least one valve may be operable to provide variable opening of its respective flow path. At least one valve may be a flap valve having a flap member operably movable between a fully closed position in which air is substantially prevented from flowing through the respective flow path past the flap member and a fully open position in which air is able to flow through the flow path past the flap member. At least one flap valve may have a flap member operably movable to at least one partially open position between the fully closed and fully open positions. At least one valve may be electronically actuatable. Where the at least one valve is a flap valve, the valve may comprise an electronic actuator for moving the flap member.

Each flow path is configured such that air can only be drawn through at least a portion of the flow path from only one of the exterior air intake and the recirculation inlet by a respective one of the first and second blowers. In each flow path in which the flow of air is regulated, the valve is located in that portion of the flow path. Accordingly, by regulating the speed of the respective blower and the valve, the amount of fresh or recirculated air drawn though the flow path can be regulated.

In an embodiment, the HVAC system comprises an electronic control system operatively connected with the valve arrangement and the first and second blowers, the control system being configured to control actuation of the at least one valve and the speeds of each of the blowers so as to regulate the flow of air through the respective flow paths. The electronic control system may be of any suitable type and may comprise a central processing unit (CPU) having a programmable processor and memory.

Each flow path is configured such that air can only be drawn through at least a portion of the flow path from only one of the exterior air intake and the recirculation inlet by a respective one of the first and second blowers. In each flow path in which the flow of air is regulated, the valve is located in that portion of the flow path. Accordingly, by regulating the speed of the respective blower and the valve, the amount of fresh or recirculated air drawn though the flow path can be regulated.

The first and second blowers may be configured to operate in parallel to draw air into the HVAC unit. The first and second blowers may be arranged side by side with their axes of rotation parallel to one another. The first and second blowers may rotate in opposite directions to draw air into the HVAC unit. The first and second blowers may be similar in size and may be able to provide matching flow rates when operated at the same speed.

In an embodiment, the system comprises at least one air mass flow sensor operatively connected to the electronic control system for determining the mass flow rate of external air drawn through the HVAC unit by at least one of the blowers. In an embodiment, an air mass flow sensor in the first flow path operatively connects to the electronic control system for determining the mass flow rate of external air passing through the first flow path. The first flow path may be permanently open. This ensures that external air is drawn into the HVAC unit whenever the first blower is operative. The first flow path may comprise a valve for regulating the flow of external air through the first flow path, wherein the valve is configured such that it does not fully close the first flow path. The system may be configured to draw at least a predetermined minimum flow of external air through the first flow path when operational.

An exterior air filter may filter external air drawn in through the external air intake. The exterior air filter may comprise a filter housing for receiving a replaceable filter cartridge. The system may have a sensor for detecting when a filter is mounted in the filter housing, the sensor being operatively connected to the electronic control system. The filter housing may be configured to accept filter cartridges of differing categories (e.g., a CAT 2 or a CAT 4 filter cartridge), and may comprise a sensor arrangement operably connected with the electronic control system for determining the type of filter mounted in the filter housing.

The system may comprise a CAT 4 (or equivalent) filter cartridge and wherein the system is configured such that when the CAT 4 (or equivalent) filter cartridge is located in the filter housing, the flow of air from the external air intake through at least one flow path, especially the fourth flow path, is blocked.

In another embodiment, a vehicle has an HVAC system as described above. The vehicle may be an agricultural or similar off-road vehicle, such as a tractor, sprayer, or the like. At least part of the HVAC unit may be located below a seat portion of an operator's seat of the vehicle. The air flow regulator may extend upwardly behind a backrest portion of the operator's seat. The external air filter may be located at an upper end of the air flow regulator.

### BRIEF DESCRIPTION OF THE DRAWINGS

Embodiments will now be described, by way of example only, with respect to the drawings, in which:

FIG. 1 is a schematic, perspective view an operator cab forming part of an agricultural vehicle, such as a tractor, comprising an embodiment of an HVAC system, parts of the cab structure being ghosted to show internal detail;

FIG. 2 is a plan view of an HVAC unit and an air intake flow management system which form part of an HVAC system suitable or use in the vehicle cab of FIG. 1, in which part of an upper covering of the air intake flow management system is removed to show internal details;

FIG. 3 is an exploded and somewhat schematic view of the HVAC unit and air intake flow management system of FIG. 2, illustrating the air flow through the air intake flow management system and the HVAC unit;

FIG. 4 is a sectioned view of the HVAC unit and air intake flow management system of FIGS. 2 and 3 taken on line A-A of FIG. 2;

FIG. 5 is a sectioned view of the HVAC unit and air intake flow management system of FIGS. 2 and 3 taken on line B-B of FIG. 2; and

FIG. 6 is a schematic plan view of an HVAC unit and an air intake flow management system which form part of an HVAC system suitable or use in the vehicle cab of FIG. 1 similar to that of FIG. 2, but illustrating an alternative layout of the air intake flow management system.

### DETAILED DESCRIPTION

Embodiments will now be described with reference to the drawings. Although the disclosure is described with reference to these specific embodiments, it will be understood that the disclosure is not limited to these embodiments. But to the contrary, the disclosure includes numerous alternatives, modifications and equivalents as will become apparent from consideration of the following detailed description.

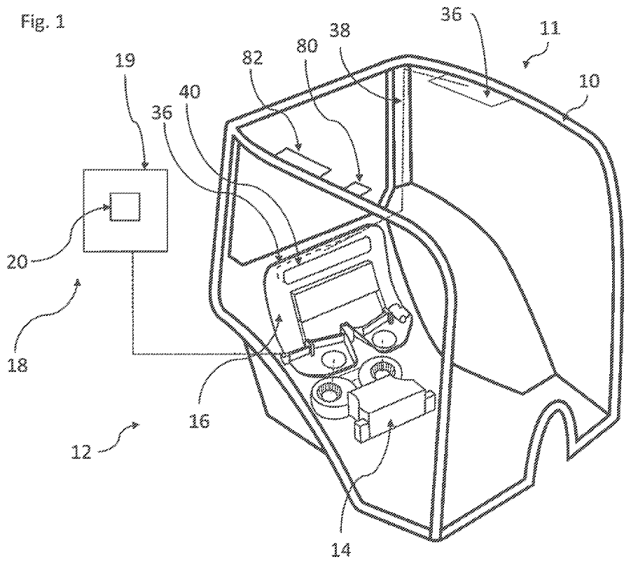

With reference initially to FIG. 1, a cab 10 defines an enclosed interior space or environment for an operator of a vehicle (indicated generally at 11). An HVAC system 12 is provided for treating air and distributing the treated air within the interior of the cab 10. The cab 10 as illustrated in FIG. 1 is the cab of an agricultural vehicle, especially a tractor. However, the HVAC system 12 as described below can be adopted in any suitable vehicle to provide treated air to an internal cabin area for a driver and/or passengers.

The HVAC system 12 includes an HVAC unit 14 operative to selectively heat and/or cool air passing through it in order to regulate the temperature of the air in the cab 10. The HVAC system 12 passes fresh air drawn from an exterior of the vehicle through the HVAC unit 14. The HVAC system may also pass recirculating air drawn from within the cab 10 through the HVAC unit 14, and has an intake air flow management system 16 for regulating the amount of exterior air 34 and recirculating air 44 drawn through the HVAC unit 14 at any given time. The HVAC system 12 also includes an electronic control system indicated schematically at 18. The control system 18 is operative to regulate various functions of the HVAC system 12 and includes and an electronic control unit (ECU) 19 having a programmable processing means (CPU) 20 and memory. The control system 18 may be part of a broader control system for the vehicle and the ECU 19 may be connected with other parts of the vehicle control system 18, by a CAN bus or any other suitable method of intercommunication.

The HVAC unit 14 has a heater 22 for heating air passing through the HVAC unit. The heater 22 may be a heater core or heat exchanger through which coolant used to cool an internal combustion engine of the vehicle is passed to transfer heat from the coolant to the air. However, other heating arrangements can be used. For example, the heater 22 could be provided with electrical heating elements for heating air passing through it. The HVAC unit 14 has an evaporator 24 for cooling air passing through the HVAC unit 14. The evaporator 24 is part of a closed-loop refrigerant system on the vehicle as is well known in the art.

Air 26 that has passed through the HVAC unit 14 (which will be referred to hereinafter as “treated air” even if not heated or cooled by the HVAC unit) is distributed within the cab interior by a distribution duct arrangement 28. As is well known, the distribution duct arrangement 28 includes a number of ducts for distributing treated air 26 to different parts of the cab interior and is provided with control valves (not shown) so that the operator and/or the control system 18 is able to regulate where in the cab 10 the treated air 26 is distributed. This may, for example, enable the operator/controller to direct some or all of the treated air 26 towards a lower region of the cab, towards the operator's head area, and or on to the windscreen or other window surfaces of the cab, or a combination of these.

Fresh (i.e., non-recirculated) air 34 is drawn into the HVAC system 12 from the exterior of the vehicle 11 through one or more exterior intakes 36. Corresponding intake air ducts (indicated generally by 38) direct the exterior air 34 from the/each intake 36 to an exterior air filter 40. In the present embodiment, the exterior air filter 40 comprises a filter housing 41 that holds a replaceable exterior air filter cartridge 42. The HVAC system 16 may be configured to use interchangeable exterior air filter cartridges 42 having different filter grades that can be easily and quickly changed to meet different filtering requirements depending on the working conditions the vehicle is operating in. The system typically includes interchangeable filter cartridges 42 of at least two different types, each offering a different category of filtration. Typically, a first type filter cartridge 42 will have a filter element suitable for filtering dust (e.g., a CAT2 filtration device), and a second type filter cartridge will be capable protecting against dust, aerosols and vapors (e.g., a CAT4 filtration device). It is expected that during normal operating conditions a CAT 2 type filter cartridge 42 for protecting against dust will be assembled in the air filter housing 41. When there is a requirement for filtering to a different standard, such as for filtering aerosols and/or vapors (for example when applying an herbicide, pesticide or similar), the first type filter cartridge 42 is removed and replaced by a second type filter cartridge. Once the requirement for a higher level of filtration has passed, the second type filter cartridge 42 is removed and replaced by a first type filter cartridge. This arrangement enables the air filtration system 12 to provide differing levels of filtration as required by changing working conditions but only requiring space to fit one air filter cartridge 42 and minimizing the overall cost of the filtration consumables.

The control system 18 includes a filter sensor (indicated schematically at 43) which is operative to detect when a filter cartridge 42 is present in the filter housing 40 and provide a signal to the ECU 19 indicative that a filter cartridge is present. The filter sensor 43 may be capable of distinguishing between the different types of filter cartridge 42 and provide a signal to the ECU 19 indicative of the type of filter cartridge 42 mounted in the filter housing 41. The filter sensor 43 may be in the form of a switch which is contacted by a formation on a filter cartridge 42 when inserted in the housing 41. Filter cartridges 42 of different categories may be configured to move the switch by differing amounts, or more than one switch may be used, each switch triggered by a filter cartridge of a particular category. Accordingly, the ECU 19 is able to determine whether or not a filter cartridge 42 is present and, if so, what category of filter is present and in particular identify when a CAT 4 filter or equivalent is in use.

Recirculating air 44 from within the cab 10 is drawn into the HVAC system through a recirculating air inlet 46. A recirculating air filter 48 is provided in the inlet 46 to clean the recirculating air 44 drawn into the HVAC system 12. The recirculating air filter 48 may be a CAT 2 standard filter or the equivalent.

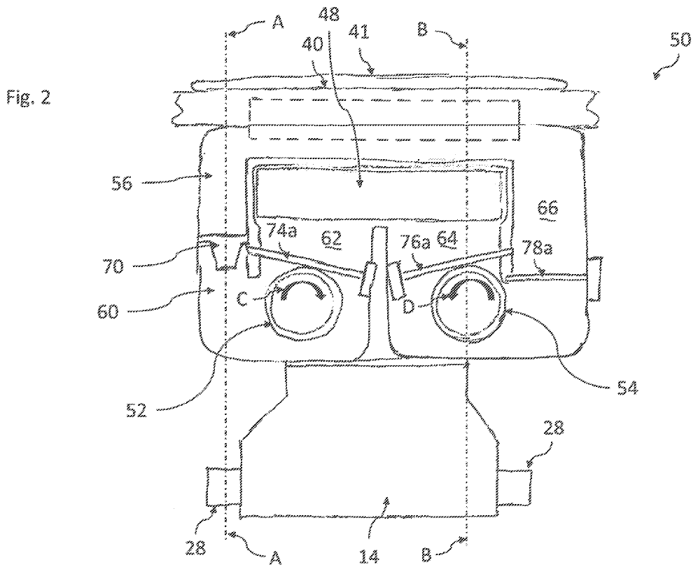

The flow of air from the exterior air filter 40 and the recirculating air inlet 46 and filter 48 to the HVAC unit 14 is regulated by an air intake flow management system 50. The air intake flow management system 50 includes first and second main blowers (fans) 52, 54 and an air flow regulator 56. The first and second main blowers 52, 54 operate in parallel upstream of the HVAC unit 14 to draw untreated but filtered air from the exterior air filter 40 and the recirculating air inlet 46 through the air flow regulator and pushes the untreated filtered air through the HVAC unit 14. The main blowers 52, 54 are located adjacent to one another and in a preferred embodiment rotate about parallel axes in opposite directions (i.e., they are contra rotating). The directions of rotation of the main blowers 52, 54 may be configured as indicated by arrows C and D in FIG. 2 so that air is pushed toward the middle between the main blowers and directed into an inlet plenum of the HVAC unit 14. The main blowers 52, 54 are each operable at varying speeds to provide a variable flow rate and the speed of each of the main blowers 52, 54 is independently controllable by the control system 18.

The air flow regulator 56 defines four separate air flow paths. A first flow path 60 fluidly connects an outlet side of the exterior air filter 40 and an inlet side of the first blower 52. A second flow path 62 fluidly connects an outlet side of the recirculating air filter 48 and the inlet side of the first blower 52. A third flow path 64 fluidly connects an outlet side of the recirculating air filter 48 and the inlet side of the second blower 54. A fourth flow path 66 fluidly connects an outlet side of the exterior air filter 40 and an inlet side of the second main blower 54.

An air mass flow sensor 70 is provided in the first flow path 60 for measuring the mass flow rate of filtered exterior air 34 flowing through the first flow path 60. The air mass sensor 70 is part of the control system 18 and is in communication with the CPU 20 in the ECU 19. The control system 18 may also include a recirculating air temperature sensor 72 for measuring the temperature of the recirculating air upstream of the HVAC unit. The recirculating air sensor 72 may be located proximal the recirculating air inlet 46 to measure the temperature of the recirculating air 44 entering the second and third passages 62, 64.

Flow through each of the second 62, third 64 and fourth 66 flow paths is controlled by a respective valve 74, 76, 78. Preferably, the valves are flap valves having a flap member 74a, 76a, 78a whose movement is controlled by an electronically controllable actuator 74b, 76b, 78b. The valves 74, 76, 78 may be simple open/closed valves in which the flaps 74a, 76a, 78a are selectively movable between a closed position in which the flaps engage with a valve seat in a passage defining at least a portion of the respective flow path to prevent air flow through the respective flow path past the flap and an open position in which flow through the respective flow path is permitted. However, some or all of the valves may be controllable to enable variable degrees of openness between the fully closed and fully open. For example, at least some of the valves may be configured so that the flaps can be moved to at least one partially open position, such as 25%, 50%, or 75% open and the like. The valves may be adjustable in one or more steps or infinitely adjustable between the fully open and fully closed positions. In one embodiment, the valves 74, 78 in the second and fourth flow paths 62, 66 are variable controlled valves and the valve 76 in the third flow path 64 is a simple open/closed valve. The actuators 74b, 76b, 78b may be electronic actuators. Operation of the valves 74, 76, 78 is controlled by the control system 18, which is operatively connected to the actuators 74b, 76b, 78b. Preferably, all the valves are controllable independently of one another. However, in some embodiments, operation of at least two of the valves may be dependent on one another, so that, for example, when one valve is opened the other is closed. Where two valves are operated dependently, a single actuator may be used to move the flaps of both valves.

Each flow path 60, 62, 64, 66 is configured such that air can be drawn through at least a portion of the flow path from only one of the exterior air intake and filter 40 and the recirculation inlet 46 by a respective one of the first and second blowers 52, 54. For those flow paths 62, 64, 66 having a valve 74, 76, 78, that portion includes the passage in which the valve is located. By controlling operation of the valves 74, 76, 78 and the speed of the first and second main bowers 52, 54, the amount and relative proportions of exterior air 34 and recirculating air 44 passed through the HVAC unit 14 into the cab 10 is regulated.

The HVAC system 12 may be operated so as to provide an over pressure in the cab. Usually a minimum over pressure in the region of 20 Pa is maintained in the cab. However, when a CAT 2 type filter is in use, an over pressure in the range of 50 to 100 Pa may be provided. The control system 18 may include a pressure sensor for monitoring the pressure inside the cab and/or a differential pressure sensor 80 for monitoring the pressure difference between the interior of the cab and the exterior. In addition, or alternatively, a manual over pressure valve 82 may be provided which opens to allow air to exit the cab if the over pressure exceeds a pre-set value.

The control system 18 may include, or be connected with, other sensors for monitoring conditions, especially climate conditions, both internally of the cab and externally. Internal sensors would typically include one or more temperature sensors (not shown) for measuring the temperature inside the cab and may also include a humidity sensor (not shown). One or more solar sensors (not shown) to measure the intensity of the light entering the cab may also be provided. The solar sensor arrangement may be capable of measuring the intensity of light entering the cab from different directions. This information can be provided as an input to the control system 18 to enable the temperature of air directed from the HVAC unit 14 to different regions of the cab to be regulated according to amount of light entering the cab from different directions. This might be used to achieve a more homogeneous temperature within the cab. Sensors for monitoring conditions externally of the cab can include one or more temperature sensors for monitoring the air temperature outside the cab. Other inputs to the control system 18 may include temperature data for the vehicle engine and/or engine coolant where this is used to heat the air. Such data can be provided by suitable sensors forming part of the engine/engine coolant system.

The HVAC system 12 can be operated in various operating modes, which are realized by opening or closing the various valves 74, 76, 78 and adjusting the rotational speed of the first and second blowers 52, 54. These modes can include, for example, a maximum cooling/heating mode, a defrosting/defogging mode, and/or an overpressure mode.

When operated in a maximum cooling/heating mode, the system is set to maximize the flow of recirculating air 44 through the HVAC unit 14 while reducing the flow of fresh external air 34 to a minimum. In contrast, when operated in a defrosting/defogging mode, the system is set to minimize the flow of recirculating air 44 and maximize the flow of fresh external air 34.

As noted above, it is often necessary for a minimum flow of fresh external air 34 into a vehicle cab 10 to be maintained at all times, and the flow of external air 34 must be kept below a maximum when the vehicle 11 is operating in hazardous conditions requiring the use of a CAT 4 type filter. For example, currently in some countries it is a legal requirement to maintain a flow rate of 30 m³/h of fresh, external air into the cab at all times when the vehicle is in use. However, when a CAT 4 type filter is used, the flow of fresh external air through the filter must be kept below a certain limit, because if the air flow is too high then there is a risk that polluted air can enter the cabin through the filter. The limit may be set by regulation and/or by the filter manufacturer. A limit in the region of around 50 m³/h is typical. The air intake flow management system 50 is configured to operate within these limits in the various modes. For example:

Example 1: During normal operation (i.e., when not in a special mode such as maximum heating/cooling or defrost/defog) with a CAT 4 type filter, the fresh, external air intake ratio is minimized. This is achieved by closing valves 74 and 78 to prevent flow through the second and fourth flow paths and controlling the speed of the first main blower 52 to maintain the flow rate of external air through the first flow path 60 (measured by the air mass sensor 70) within the required limits (e.g., higher than the minimum flow required (30 m³/h) but not more than the maximum flow permitted flow for the CAT 4 filter of 50 m³/h). The operation of the second main blower 54 and the valve 76 are controlled to provide a required flow of recirculating air through the third flow path 64 to meet the set-point temperature.

Example 2: During normal operation (i.e., when not in a special mode such as maximum heating/cooling or defrost/defog) with a CAT 2 filter, higher levels of external air 34 can be drawn through the HVAC unit 14 than is permitted with CAT 4 use. Thus when a CAT 2 type filter is in use, all the air flow paths may be used with the valves and main blowers being controlled to achieve the temperature set point, subject to a minimum flow of fresh, external air (30 m³/h) being maintained through the first flow path 60.

Example 3: When operating in a maximum heating/cooling mode, the amount of external air 34 drawn through the HVAC unit 14 is minimized by closing valve 78 to stop external air flowing through the fourth flow path 66 and opening valve 76 so that recirculating air 44 is drawn in through the third flow path 64. With the fourth flow path 66 closed, external air 34 is only drawn into the HVAC unit 14 through the first flow path 60. The speed of the first main blower 52 is controlled to maintain but not exceed significantly the minimum required external air flow (30 m³/h) through the first flow path 60 as measured by the air mass sensor 70 and the speed of the second main blower 54 is increased to maximize the flow of recirculating air 44 drawn through the third flow path 64. The valve 74 may also be opened to allow recirculating air to be drawn in through the second flow path 62 by the first main blower 52 but the speed of the first main blower is controlled so that the flow of external air through the first flow path 60 is maintained at around but not significantly above the minimum required level (30 m³/h).

Example 4: When operating in a defrosting/defogging mode, the valves 74 and 76 are closed to prevent recirculating air 44 being drawn into the HVAC unit 14 through the second and third flow paths 62, 64 and the valve 78 is opened to enable fresh, external air 34 to be drawn in through the fourth flow path 66. In this case, the first and second main blowers 52, 54 can be operated at maximum speed, subject to the requirement to keep overpressure in the cab within limits. If a CAT 4 filter is in use, the amount of external air drawn in must be maintained below the maximum permitted limit (50 m³/h). In this case, the valve 78 may be closed so that external air is only drawn in through the first air flow path 60 and the speed of the first main blower 52 regulated so as not to exceed the permitted maximum flow rate of external air.

Where an overpressure in the cab is required, operation of the HVAC system 12 will be regulated to maintain the overpressure in the cab 10 within required limits at all times.

Operation of the various modes may be initiated by an operator via a user interface, such as a touch sensitive screen on a monitor provided in the cab or by other types of switch or user controls. Alternatively, or in addition, at least some modes of operation may be initiated by the control system 18 automatically in dependence on inputs from various sensors according to a predefined protocol. The user interface may enable an operator to select and/or inhibit and/or modify automatic functioning of the control system 18 in this manner.

In an alternative embodiment, the valve 78 for the fourth flow path 66 can be omitted. In this case, the system is configured such that when a CAT 4 type filter cartridge 42 is inserted in the filter housing 41, flow through the fourth air flow path 66 is blocked so that external air 34 can only be drawn into the HVAC unit 14 by the first main blower 52 through the first flow path 60. This enables the flow rate of the external air drawn though the CAT 4 type filter to be regulated within the required limits by controlling the speed of the first main blower 52.

In a modification, the air flow regulator 56 may have a further valve (not shown) for regulating the flow of external air 34 through the first air flow path 60. In this case, the valve is configured so that it does not fully close the first flow path 60 such that a minimum flow of external air can be drawn through the first flow path 60 at all times when the HVAC system 12 is operational. The valve could be a flap valve that does not fully close, for example. In this embodiment, the air mass sensor 70 could be omitted and the system configured such that speed of the first blower 52 is regulated to provide the required flow of external air through the first flow path in dependence on the open cross-sectional area for flow through the first flow path. The control system 18 in this case may be provided with data enabling the system 18 determine the available cross-sectional area for flow past the valve (e.g., data relating to the degree of opening of the valve) and is configured to determine an appropriate speed for the first blower 52 to provide a required flow rate of external air through the first flow path 60. A similar arrangement could be provided if there is no valve in the first flow path 60 to enable the system 12 to operate without a flow mass sensor 70.

In a further modification, the passage in which the air mass sensor 70 is located could be modified to provide a further flow path for external air 34 parallel to the first flow path 60 with a further valve (not shown) for regulating the flow of external air 34 through the further air flow path under the control of the control system 18. The further valve could be a flap valve located to one side of the air mass sensor 70. The arrangement would provide a further regulated flow path for external air 34 while the first flow path 60 through the air mass sensor 70 remains permanently open.

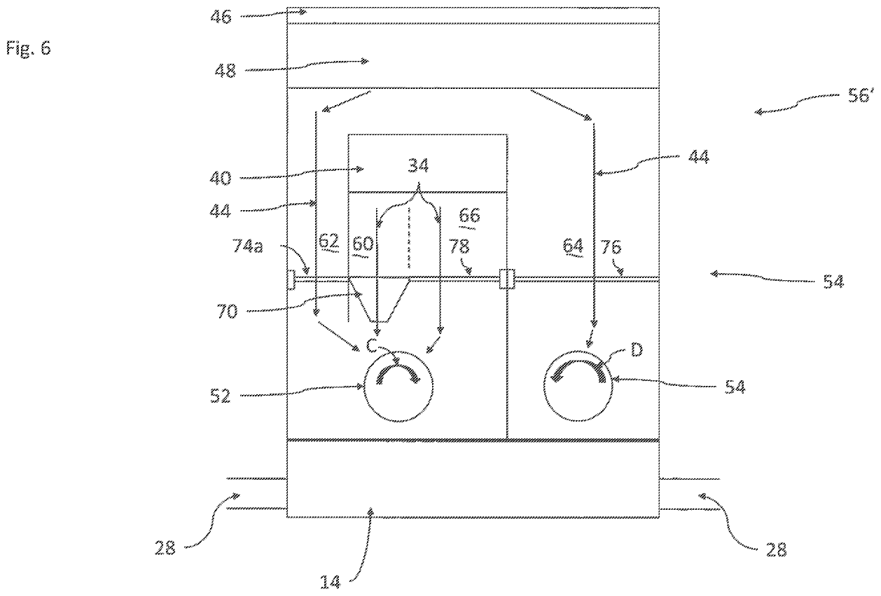

FIG. 6 illustrates schematically an alternative embodiment of the air flow regulator 56′ illustrating alternative locations for the external air filter 40 and the recirculating air inlet 46 and filter 48. In this embodiment, the second blower 54 is only operative to draw recirculating air 44 from the recirculating air inlet 46 and filter 48 through the third flow path 64. Flow of recirculating air 44 through the third flow path 64 is regulated by a flap valve 76. All the external air 34 is drawn in by the first blower 52. To this end, a first flow path 60 connects the inlet side of the first blower 52 to an outlet side of the exterior air filter 40 through an air mass flow sensor 70. The first flow path 60 is permanently open. A fourth flow path 66 also connects the inlet side of the first blower 52 to an outlet side of the exterior air filter 40. A flap valve 78 is operative to regulate the flow of air through the fourth flow path 66. The first flow path 60 upstream of the air mass sensor 70 and the fourth flow path 66 upstream of the valve 78 share a common passageway. A second flow path 62 fluidly connects the inlet side of the first blower 52 to an outlet side of the recirculation inlet 46 and filter 48. Flow of recirculating air 44 through the second flow path 62 is regulated by a flap valve 74.

As with the previous embodiment, the valves 74, 76, 78 are electronically actuatable under control of control system 18 and CPU 19 and can be independently opened and closed. By opening and closing the valves 74, 76, 78 and controlling the speeds of the first and second blowers 52, 54, the control system 18 is able to regulate flow of exterior air 34 and recirculating air 44 through the HVAC unit 14 in a similar manner to the first embodiment as described above. When the flow of exterior air 34 is to be minimized, valve 78 is closed to stop external air flowing through the fourth flow path 66. With the fourth flow path 66 closed, external air 34 is only drawn into the HVAC unit 14 through the first flow path 60. The speed of the first main blower 52 is controlled to maintain but not exceed significantly the minimum required external air flow (30 m³/h) through the first flow path 60 as measured by the air mass sensor 70. When a flow of recirculating air 44 is required, valve 76 is opened so that recirculating air is drawn in through the third flow path 64, and the speed of the second main blower 54 is controlled to provide the required flow of recirculating air drawn through the third flow path 64. The valve 74 may also be opened to allow recirculating air to be drawn in through the second flow path 62 by the first main blower 52, but the speed of the first main blower is controlled so that the flow of external air through the first flow path 60 is maintained at around but not significantly above the minimum required level (30 m³/h).

When the flow of external air is to maximized, the valve 78 can be opened and the valve 62 closed. The speed of the first blower 52 can be maximized subject to the requirements for overpressure in the cab. Where no recirculating air is required, the valve 76 can be closed and/or the second blower 54 stopped.

It will be appreciated that a wide variety of different flow rates for external and/or recirculating air can be provided by opening and closing the various valves and regulating the speeds of the first and second blowers.

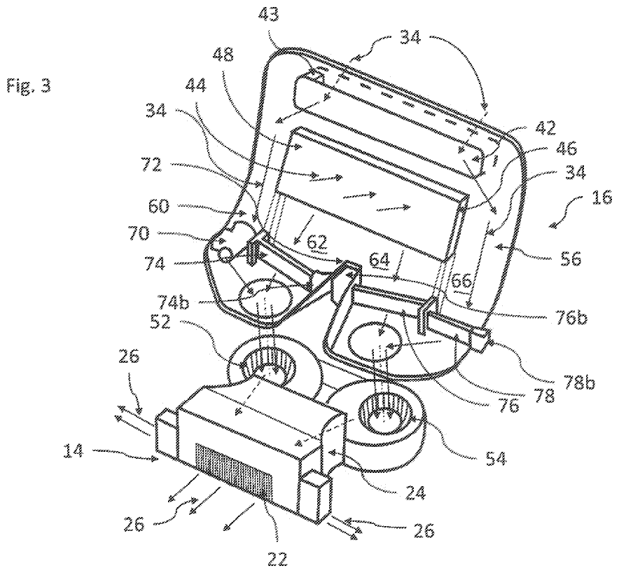

It should also be appreciated that the relative positions of the various flow paths and the first and second blowers can be varied. FIG. 1 for example shows the positions of the flow paths reversed left to right compared with FIGS. 2 and 3, with the first flow path with the air mass flow sensor on the right-hand side and the fourth flow path on the left. In this case, the blower on the right can be considered the first blower and that on the left the second blower.

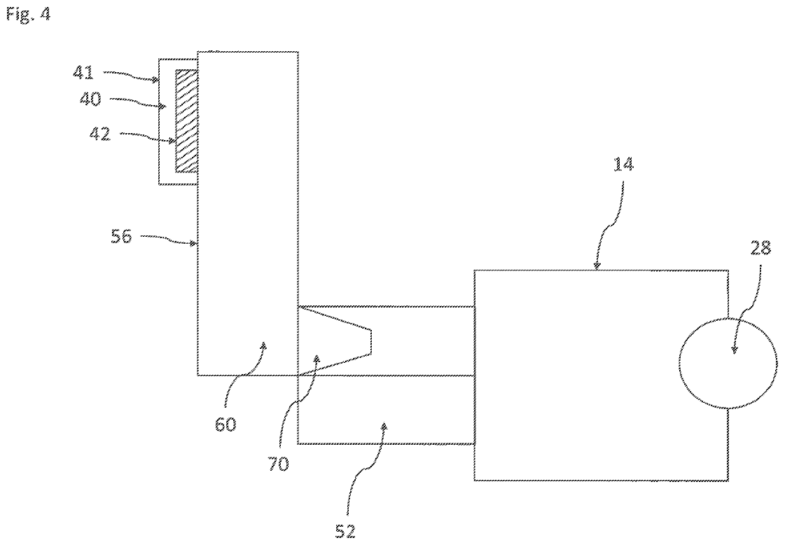

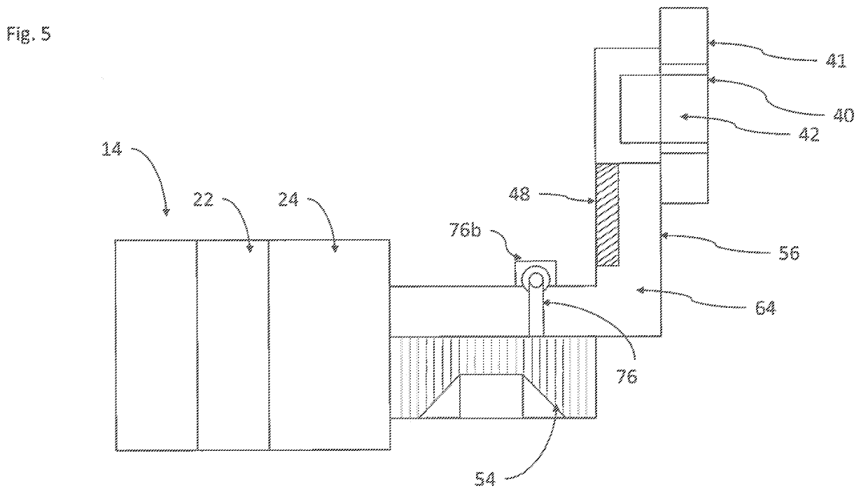

The HVAC unit 14, the air intake flow management system 50, and the external air filter 40 are conveniently mounted at the bottom and towards the rear of the cab. In some embodiments, the HVAC unit 14, the air intake flow management system 50, and the external air filter 40 are located below and behind an operator seat in the cab. As can be seen from FIG. 1, at least part of the HVAC unit 14 and the first and second main blowers 52, 54 are conveniently located below a seat portion of an operator/driver seat with the air flow regulator 56 extending up behind a back rest portion of the operator seat. In the embodiment of FIGS. 1 to 5, the exterior air filter 40 is conveniently provided at an upper end region of the air flow regulator 56 so as to be located behind the backrest of the operator seat where it is easily accessible and the recirculating air inlet 46 and filter 48 may be accommodated below the external air filter. However, other configurations are possible as illustrated in FIG. 6. Furthermore, the principles of the HVAC system 12 can be adopted regardless of the location of the HVAC unit 14 and air flow management system 16. The HVAC unit 14 and intake air flow management system 16 could be accommodated in a roof space of the cab, for example.

In an alternative embodiment where space and/or cost permit, the HVAC system can be configured so that two external air filters are installed at the same time. The two filters may be of different categories such that one may be a CAT 2 type filter and the other a CAT 4 type filter for example. In this embodiment, a further intake air flow arrangement will be provided upstream of the intake air flow regulator 56 so that external air can be drawn through only one of the filters into the first and fourth flow paths 60, 66 at a time. Thus, in normal operating conditions, external air will only be drawn through a lower grade filter, say a CAT 2 filter. When the vehicle is operating in more hazardous conditions requiring a higher level of filtration, the additional air flow arrangement is switched so that external air is drawn only through the higher grade, e.g., CAT 4, filter. The system can be configured that external air can only be drawn from a higher grade, e.g., CAT 4, filter through the first flow path 60 with flow through the fourth flow path 66 blocked. In this case, the valve 78 in the fourth flow path of the air flow regulator could be omitted.

Various modifications to the vehicle HVAC system will be apparent to those skilled in the art.

1. A vehicle HVAC system comprising:
an HVAC unit;
first and second variable speed blowers, each blower being controllable independent of the other and operative in use to selectively draw into the HVAC unit at least one of exterior air from an exterior air intake to and recirculated air from a recirculation inlet; and
an air flow regulator defining a plurality of flow paths, each flow path configured such that, in use, air is drawn through the flow path from a respective one of the exterior air intake and the recirculation inlet only by a respective one of the first and second blowers, wherein the air flow regulator comprises at least one valve configured to selectively regulate a flow of air through at least one of the flow paths.

2. The vehicle HVAC system of claim 1, wherein the air flow regulator defines:
a first flow path through which air is drawn from the exterior air intake by the first blower;
a second flow path through which air is drawn from the recirculation air inlet by the first blower; and
a third flow path through which air is drawn from the recirculation air inlet by the second blower;
wherein the at least one valve is configured to selectively and regulate the flow of air through at least the second and third flow paths.

3. The vehicle HVAC system of claim 2, wherein the air flow regulator further defines a fourth flow path through which air is drawn from the exterior air intake by one of the first blower and the second blower.

4. (canceled)

5. The vehicle HVAC system of claim 3, wherein the at least one valve is configured to selectively regulate the flow of air through the fourth flow path.

6. The vehicle HVAC system of claim 1, wherein the at least one valve comprises a respective valve in each flow path in which a flow of air is regulated, each valve being operable to selectively open and close its respective flow path.

7. The vehicle HVAC system of claim 6, wherein the at least one valve is operable to provide variable opening of its respective flow path.

8. The vehicle HVAC system of claim 6, wherein the at least one valve comprises a flap valve having a flap member operably movable between a fully closed position in which air is substantially prevented from flowing through the respective flow path past the flap member and a fully open position in which air is able to flow through the flow path past the flap member.

9. The vehicle HVAC system of claim 8, wherein the at least one flap valve has a flap member operably movable to at least one partially open position between the fully closed position and the fully open position.

10. The vehicle HVAC system of claim 6, wherein each valve is electronically actuatable.

11. The vehicle HVAC system of claim 6, wherein the system comprises an electronic control system operatively connected with the at least one valve and configured to control actuation of the at least one valve and the speed of each of the first and second blowers independently of one another so as to regulate the flow of air through the respective flow paths.

12. The vehicle HVAC system of claim 11, wherein the system comprises an air mass flow sensor in the first flow path operatively connected to the electronic control system for determining the mass flow rate of air passing through the first flow path.

13. The vehicle HVAC system of claim 12, wherein the first flow path is configured to be at least partially open at all times.

14. The vehicle HVAC system of claim 1, wherein the first and second blowers are located side by side, the blowers configured to direct air into an inlet plenum of the HVAC unit.

15. The vehicle HVAC system of claim 14, wherein the first and second blowers rotate in opposite directions to draw air into the HVAC unit.

16. The vehicle HVAC system of claim 1, further comprising an exterior air filter configured to filter exterior air drawn in through the exterior air intake.

17. The vehicle HVAC system of claim 16, wherein the exterior air filter comprises a filter housing configured to receive a replaceable filter cartridge.

18. The vehicle HVAC system of claim 17, further comprising:
an electronic control system connected with the at least one valve and configured to control actuation of the at least one valve and the speed of each of the first and second blowers independently of one another to regulate the flow of air through the respective flow paths; and
at least one filter sensor configured to detect when a filter is mounted in the filter housing, wherein the at least one filter sensor is operatively connected to the electronic control system.

19. The vehicle HVAC system of claim 18, wherein the system comprises at least one filter sensor operably connected with the electronic control system and configured to determine a type of filter mounted in the filter housing.

20. The vehicle HVAC system of claim 19, wherein the air flow regulator further defines a fourth flow path through which air is drawn from the exterior air intake by one of the first blower and the second blower, the system further comprising a CAT 4 type filter cartridge and wherein the system is configured such that when the CAT 4 type filter cartridge is located in the filter housing, the flow of air from the exterior air intake through at least one flow path is blocked.
